(19) United States
(12) Patent Application Publication
(10) Pub. No.: US 2018/0285986 A1
(43) Pub. Date: Oct. 4, 2018

(54) An Activity-Centric System And Method For Relationship Matching

(71) Applicant: SUPERDATE NETWORKS INC., Vancouver (CA)

(72) Inventors: Stevan PERRY, Vancouver (CA); Dominic STANN, Vancouver (CA); James PETRY, Seal Beach, CA (US)

(21) Appl. No.: 15/763,971

(22) PCT Filed: Sep. 29, 2016
(86) PCT No.: PCT/CA2016/051136

§ 371 Date: Mar. 28, 2018

Related U.S. Application Data
(60) Provisional application No. 62/234,177, filed on Sep. 29, 2015.

(51) Int. Cl. G06Q 50/00; G06F 17/30; H04L 12/58

(52) U.S. Cl. CPC G06Q 50/01; H04L 51/32; G06F 17/30864

(57) ABSTRACT

An online dating and relationship system relies on common interests in, and arranging for, specific face-to-face in-person activities. Potential activities are ranked by an activity ranking engine drawing on activity-related attributes of the users and of the activities. Mutual selection of an in-person activity enables the users to vet potential matches and to proceed to engage in the activity together. The ranking and match engines may take into account intrinsic user and activity attributes as well as activity-related attributes derived from the behavior of the users in relation to the activities.

### FIELD OF THE INVENTION

This invention relates to personal relationship applications and systems. In particular, this invention relates to matching individual participants in an online dating and relationship system.

### BACKGROUND OF THE INVENTION

Online dating and relationship systems typically rely on self-reporting of user attributes and proclaimed desirable attributes for other (target) users.

Match engines rely on applying analytics to such attributes to provide recommendations for matching users to one another based in part on personal attributes such as (for example) gender, age, physical appearance, financial resources and occupation and sometimes also on the expressed desirable attributes of target users.

Self-defining a user's attributes may be a necessary element of dating and relationship matching systems but it has limitations. The self-reporting of personal attributes is subject to both self-bias and marketing bias, while the identification of desirable attributes in other users may in fact not be accurately assessed by the user. It is desirable to determine an alternative and potentially more reliable means of matching users that does not rely solely on user-defined personal attributes and user-defined desirable personal attributes of target users.

Some systems involve the users viewing the profiles of other users, including an image of the other user and personal attributes of the user, and either contacting the target user or allowing an anonymizing system to put the users in contact with one another only if the interest in contacting one another is mutual. While such approach is to some extent self-filtering, nonetheless for users with serious intent, it requires an analysis of the target user and of the profile attributes including some guesswork, extrapolation and prediction. A more empirical and less analytical means of matching users may improve the outcomes and the satisfaction experienced by users of the system.

The personal attributes collected by prior art systems include fields of interests of the users. For example, U.S. Pat. No. 8,635,167 issued to eHarmony, Inc. discloses collecting information as to interests such as camping and attending opera. The system or the users then consider the commonality of such stated interests in recommending a match or contacting another user.

U.S. Pat. No. 8,635,167 further discloses evaluating the satisfaction experienced by a user in engaging with another user and using an approximation of such satisfaction to predict that user's suitability for further relationships. The assessment of satisfaction may include securing survey feedback from the users as to their experience in the match.

It is also known to track the user's interface with the relationship system for the purpose of generating a behavioral attribute or feature of the user for use in further match recommendations. U.S. Pat. No. 9,449,282 issued to Match.com, LLC discloses tracking the online activity of the user in viewing profiles, sending messages and responding to messages. Such an approach seeks to optimize the ability to generate match recommendations using data from the online experience, including online behavioral data and self-reported attribute data.

The foregoing prior art uses self-reported overt personal attributes and interests to recommend matches between users of the systems involved.

It is an object of this invention to provide a dating and relationship matching system that provides a more reliable matching of users, centering on face-to-face in-person activities rather than merely a metric based on user-reported personal attributes. In this description and in the claims, “in-person” activity means a face-to-face activity.

These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

The present invention provides a means for matching users of a dating and relationship system by reference to in-person activities rather than solely on the basis of self-reported attributes. An individual's interest or participation in certain in-person activities may be implicitly telling of the person's personality without the need to analyze personality characteristics and metrics.

Embodiments of the invention rely on a user's expression of interest in in-person activities or on actual participation and satisfaction in participating in in-person activities.

By targeting and facilitating in-person activities, users can expedite the ultimate objective of in-person contact with compatible users without necessarily engaging other protocols within the online system.

According to one aspect of the invention, users of the dating and relationship system of the invention establish personal profiles and are prompted to rank their preferences in a series of potential in-person activities that are drawn from a database of activities. The potential in-person activities may be supplemented by newly introduced user-defined activities. An initial user attribute set is thereby established for each user, including personal attributes and activity-related attributes.

Upon a user seeking out a partner or an activity, an activities ranking engine generates a ranked set of in-person activities for the purposes of displaying the set in ranked order to the user. The ranking engine operates on a number of input factors, which preferably include factors drawn from the attribute set of the user in question.

The user browses the activities of interest and eventually selects one in-person activity or more than one such activity in a ranked order. The browsing activity of the user and the user's eventual selection are tracked and recorded for the purpose of future activity ranking operations by the ranking engine. Such browsing activity and eventual selection of an activity are used to populate the user's own attribute set to account for the user's apparent activity interests and selection history. It may also be used to update activity-specific attributes for use in ranking activities for other users.

A match engine determines at least one and preferably a plurality of profiles of other users to be displayed to the first user as potential matches in response to the first user's selection of one or more in-person activities. A minimum requirement for each potential match is the expression by the potential match of an interest in the same in-person activity as the user.

The user views the profiles of the potential matches and selects one or more potential matches. In the event that a potential match has also selected the user as a potential match, a match notice is dispatched to the user and the match and a messaging facility is made available to them.

The system of the invention solicits feedback from the user and from the match regarding the satisfaction with participation in the in-person activity and the success of the particular match. The feedback is used by the activity ranking engine for future activity rankings and by the match engine for future potential match rankings.

A user interface provides an opportunity for users who have actually participated in a given in-person activity to overtly propose a superlative characterization of such activity (referred to herein as a “superdate” or “supering”), such proposal being used to populate a set of activity-specific attributes. A user interface may also provide an opportunity for users to express approval of given in-person activities prior to participating in such activities, such approval also being used to populate the set of activity-specific attributes. The approval attributes of specific activities are one of the factors relied on by the activity ranking engine of the invention.

The activity ranking engine according to the preferred embodiment operates on a set of intrinsic in-person activity attributes such as the name(s) of the in-person activity, its categorization (e.g. outdoor sports, casual, dining) its location, and if applicable the date of the activity. Such intrinsic activity-specific attributes may be populated by a user who proposes a new activity at a remote user interface, curated by the host application at the application server, by a vendor of an in-person activity or by a third party sponsor at a third party location.

The activity ranking engine also relies on experiential activity-specific attributes. The experiences are gathered from:
a. users' ranking of the activity at the remote user interface upon registration;
b. users' browsing and subscribing to activities when searching for a match through tracking the user's online activity at the application server. These include time spent examining the activity, users' comments on or supering the activity, users subscribing to participate in the activity, the number of potential matches selected or rejected by users for the activity;
c. actual participation in the in-person activity as determined from a variety of sources. The sources include from monitoring participation in the in-person activity at the activity location, comments about the activity as collected by the application server based on the analysis of messaging by users who participated in the activity, feedback solicited by the host application from the activity participants, spontaneous supering of the activity by participants and tracking of participants' GPS information;
d. the rate of success in satisfactory matches achieved as a result of participation in the in-person activity, as determined by user feedback to the application server.

The match engine according to the preferred embodiment operates on a set of attributes pertaining to the users of the system, including both intrinsic user attributes (e.g. age, gender, race, physical characteristics, health, financial status, sexual preferences) and experiential user activity attributes, i.e. attributes that pertain to in-person activities associated with the user. Such user activity attributes are populated based on various sources:
a. Upon registration, a user ranks his or her preferred activities, and may rank activities that the user believes likely matches would like (which do not necessarily coincide with the user's own preferred activities).
b. While seeking a match through the system of the invention, the user undergoes experiences such as browsing certain activities, commenting on certain activities, supering activities, subscribing to participate in an in-person activity, and selecting or rejecting potential matches for the selected activity.
c. Upon participation in an in-person activity, a user may super an activity, sign in and sign out at an activity location, offer or respond to solicited feedback about an activity and about the success of a match with another user as a result of participation in an in-person activity.

Such information is used to populate the user activity attributes which are used, among other inputs, in the match engine for generating potential matches upon a user selecting a given activity.

According to the preferred embodiment, the data relied on by the match engine comprises user attributes in a first subset that relate to a user's activities interests and activities experiences and a second subset that relate to activities associated with the potential matches for that user. The latter is conceptualized as an activities index derived not from the user directly, but as indirectly attributed to the user from the interest or involvement in activities on the part of potential matches in whom the user has expressed an interest (for example by selecting or rejecting potential matches presented to the user or by the user's experience with selected matches).

A weighting function is applied to the user activity attributes in each subset to determine future potential matches. The same approach may be used by the activity ranking engine of the invention.

In one aspect, the invention comprises an online system for matching remote users through participation in in-person activities at activity venues, comprising a host application server and a plurality of remote users each having a remote computing device having a user interface. The system comprises a database of in-person activities having a set of attributes that include attributes pertaining to the in-person activities and activity-related attributes of users. An activity-ranking engine draws on at least the attributes pertaining to the in-person activities and the activity-related attributes of the users to determine a first ranked set of activities of likely interest to a first user. A display on the user interface displays the first ranked set of activities to the first user. The same activity-ranking operation and activity display is performed separately for at least one second user, and preferably for a plurality of other users, on those remote users' interfaces. A selection icon or other means are provided on the user interfaces enabling each user to select an in-person activity in which to participate.

By receiving and assessing the selections of the various users, the application determines when the first user and a second user have selected the same activity for participation. When that occurs, a display is presented to the first user using the first user interface to notify the first user that the second user has selected the same activity. The user interface allows the first user to select or reject the second user as a candidate to attend the activity in question as a date with the first user. The same display and selection/rejection occurs for the second user in relation to the candidacy of the first user.

A notification facility associated with the application and with the users' user interfaces notified the first and second users when they have mutually selected one another for joint participation in the mutually selected activity.

The system may further include a match engine for determining, based on the set of attributes, that the first user and the second user are compatible as potential matches for a relationship.

Preferably, the notification facility also presents to the first user and the second user means for establishing communication between them for the purpose of follow through with joint participation in the in-person activity.

In another aspect, the invention is a method of matching users of an online dating system having a host application residing on a server and serving a plurality of remote users on respective computing devices. The method comprises:
prompting a plurality of the users to rank their respective preferences in a series of potential in-person activities that are drawn from a database of activities associated with the application;
populating the database with attributes for each of the users, including at least activity-related attributes for the respective users;
in response to an action from a first user (for example logging on to indicate a desire to be matched through an activity), generating a first set of in-person activities, based on one or more of the activity-related attributes relating to that first user, and displaying them to the first user as an invitation to subscribe for participation in one of the activities;
receiving from the first user a selection of a first specific activity from among the set of activities displayed to that user;
in response to an action from a second user, generating a second set of the in-person activities, based on one or more of the activity-related attributes relating to that second user, and displaying them to the second user as an invitation to subscribe for participation in one of the activities;
receiving from the second user a selection of a second specific activity from among the second set of activities displayed to that second user;
assessing whether said second specific activity is the same one as the first specific activity;
if so, assessing whether the second user is a compatible potential relationship match for the first user, based at least on personal attributes of each of the first and second user, and further based on activity-related attributes of each of the first and second user;
if so, displaying identifying information regarding the second user to the first user and preferably vice versa;
upon the first user indicating a desire to participate in the first specific activity with the second user and vice versa, displaying to each of the first and second users a notification of a mutual desire to participate in that activity jointly.

The method may further include the steps of:
displaying to the first user identifying information for respective ones of a plurality of users who have selected that same activity; and, upon the first user indicating a desire to participate in that same activity with a specific user who has also selected the same activity, displaying to each of said first user and said specific one of said plurality of users a notification of a mutual desire to participate in said activity jointly.

The method may:
determine that the first and second users have actually participated in the first specific activity together;
receive feedback regarding satisfaction on the part of the first or second user with their participation in the first specific activity;
populate the database with activity-specific attributes corresponding to such satisfaction, the first user and the first specific activity.

The method may further comprise the steps of receiving from the first user a proposed superlative characterization of the first specific activity and populating the database with at least one activity-specific attribute reflecting the proposed superlative characterization. The superlative characterization may be applied as an attribute to the activity directly or such application may only occur after factoring in other proposals from other users for such characterization.

The method may involve activity-specific attributes based on data derived from at least one of the following:
the first user ranking of a set of in-person activities on one of the computing devices;
browsing of activities by the first user;
the first user subscribing to participate in an activity;
the user proposing a superlative characterization for an activity;
the first user selecting or rejecting proposed other users for jointly participating with in an activity;
the first user's actual participation in an activity;
GPS information indicating the first user's participation in an activity;
explicit feedback from the first user in relation to participation in an activity;
data mining of messages involving the first user and relating to an activity;
a success rate as a result of users participating in an activity.

The foregoing may cover only some of the aspects of the invention. Other aspects of the invention may be appreciated by reference to the following description of at least one preferred mode for carrying out the invention in terms of one or more examples. The following mode(s) for carrying out the invention is not a definition of the invention itself, but is only an example that embodies the inventive features of the invention.

### BRIEF DESCRIPTION OF THE DRAWINGS

At least one mode for carrying out the invention in terms of one or more examples will be described by reference to the drawings thereof in which:

FIG. 1 is a diagram of a network environment of the preferred embodiment of the invention;

FIG. 2 is an overview of the process flow of the invention;

FIG. 3 is a block diagram of the host application components according to the preferred embodiment;

FIG. 4 is a flowchart of the registration process of the preferred embodiment of the invention;

FIG. 5 is a flowchart of the activity selection, user matching and activity participation process of the preferred embodiment;

FIG. 6 is a diagram illustrating the inputs for the activity attributes according to the preferred embodiment;

FIG. 7 is a diagram illustrating the inputs for the user attributes according to the preferred embodiment;

FIG. 8 is an illustration of the operation of a matching algorithm for the preferred embodiment;

FIG. 9 is an illustration of the operation of two different matching algorithms for the purpose of presenting a mix of alternative activity recommendations to a user;

FIG. 10 is a table of user attributes according to the preferred embodiment; and,

FIG. 11 is a table of activity attributes according to the preferred embodiment.

### DETAILED DESCRIPTION OF THE PREFERRED EMBODIMENT

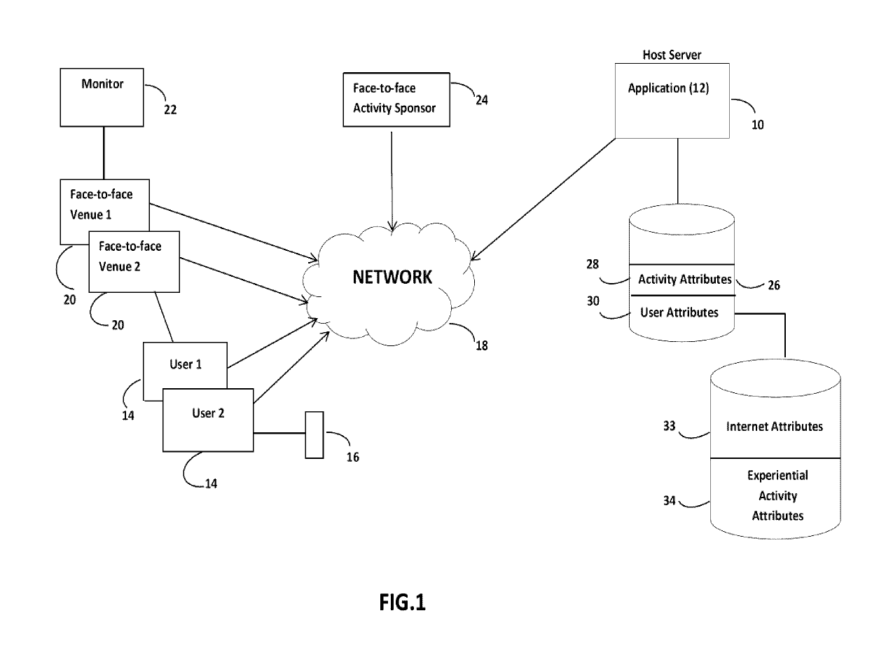

Referring to FIG. 1, a host server 10 supports a host application 12 that is accessed by remote users 14 on communication devices 16 through a communication network 18. Each communication device 16 includes a user interface.

The system of the invention is designed to direct users 14 to engage with other users 14 in in-person activities at face-to-face venues 20. Venues 20 preferably include means 22 for communicating activity and participant-related information to the host application 12.

In-person activity sponsors 24 are in communication with the host application 12 for the purposes of submitting new in-person activities for treatment by the host application.

The host application 12 is associated with a database 26 comprising a set of user attributes 28 and a set of activity attributes 30. The user attributes 28 comprise a subset of intrinsic user attributes 33 and experiential user activity attributes 34.

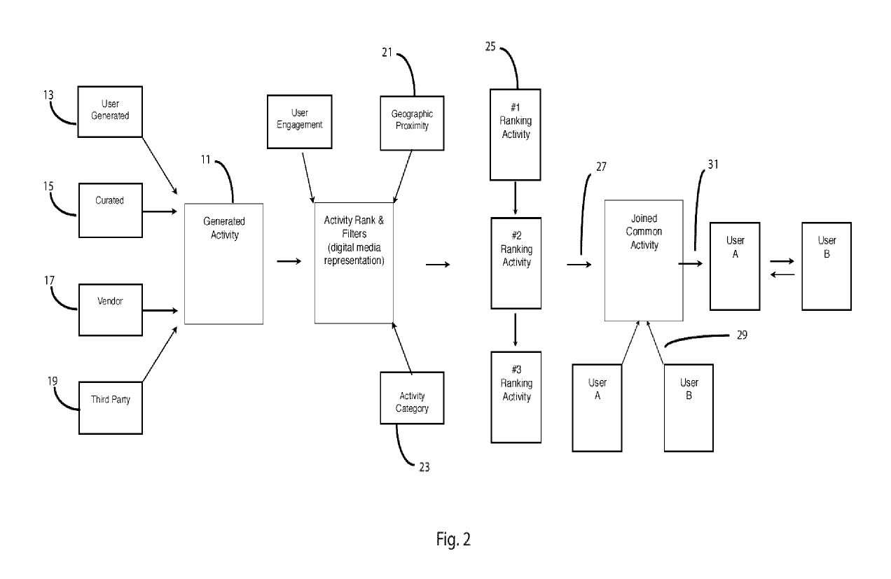

FIG. 2 illustrates the general flow of the process of the invention. In-person activities 11 are generated by users (13), curated by the host application (15), generated by vendors of in-person activates (17) or by sponsors (19) of activities or of the system of the invention. The user may apply a filter to the activities that the user is interested in, for example by geographic proximity (21) or by type/category (23) of activity. The application 12 causes the display (25) of a set of ranked activities to the user.

The user selects (27) the in-person activity from among those displayed that the user wishes to join/participate in. If or when another user joins the same activity through the system of the invention, a match is declared (29) by the application and the two users are offered to be put in touch (31) with one another for the purpose of following through together with the in-person activity that they have both selected.

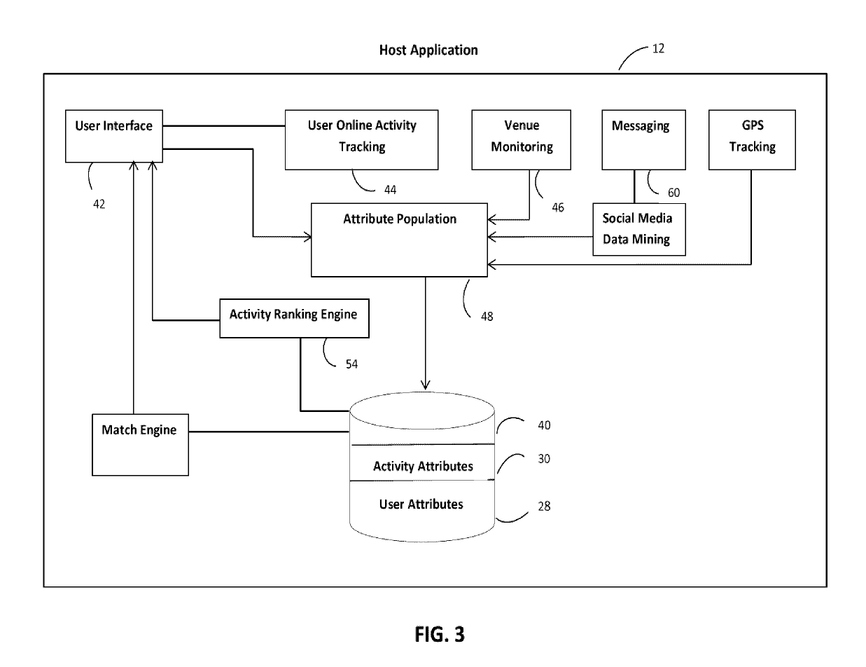

FIG. 3 illustrates the principal components of the host application and its associated database. A database 40 associated with the host application 12 stores user attributes 28 and activity attributes 30 that are compiled based on inputs from users 14 in communication with the application's user interface 42, from tracking of users' online actions and selections as they relate to in-person activities by means of a user online activity tracking module 44, from activity sponsors 24 who also communicate with the application through the user interface 42, from the system host itself, or from venue monitoring devices and systems 22 communicating with the host application 12 through the venue interface 46.

Such inputs are parsed by an attribute population module 48 that populates the appropriate activity 50 or user 52 attributes in database 40.

An activity ranking engine 54 draws on the activity attributes and the user attributes to select activities to display through user interface 42 to a given user 14 seeking a match.

The activities attributes apply to a list of activities that is maintained by the host application 12 and may be updated from time to time based on inputs posted by users 14, the system host 12 or activity sponsors 24. In the preferred embodiment, users express interest in one or more activities through the application 12. Generally speaking, the application tracks such expressions of interest and undertakes a matching protocol for users that includes the common interest in an in-person activity.

A wide variety of in-person activities are supported by the system. They include by way of non-limiting examples, recreational activities, hobbies, playing or watching sports or games, hikes, rounds of golf, kayaking, salsa dancing or ice skating, concert, going to an art gallery, installation or live performance that pertains to arts and culture, activities relating to food, culture and cuisine. This may include getting together at a restaurant or home cooking an activity that is casual in nature and may not involve as much planning. An example of this would be going for a cup of coffee or sitting at a park and having a conversation.

Once a ranked list of activities has been presented to the user 14 and the user 14 has selected a desired activity from among the displayed activities, a match engine 56 draws on the user attributes of other users, including activity-related attributes, to generate potential matches for the user. The potential matches are other users who have also expressed an interest in participating in the same selected in-person activity, and which the match engine otherwise determines to be a potentially suitable match with the user.

User online activity tracking module 44 tracks the user's interaction with the activities display to determine such metrics as lingering time on a given activity, scrolling through details of the activity and selecting or deselecting activities. Such occult interest in activities may be used to populate the user attributes that relate to activities of interest. Such occult activity interests are given less weight than explicitly expressed user interests in the algorithm that runs the activity ranking engine 54.

A messaging module 60 is engaged when users have been matched around a mutually selected activity, providing an in-application facility for the users to interact for the purpose of participating in the activity together. Alternatively the users may be directed to other social networking or messaging applications to communicate with one another.

A GPS tracking module operates to track, preferably with the user's permission, the location of the mobile device of a user, for the purpose of determining the user's attendance at an in-person activity, including the duration of such attendance.

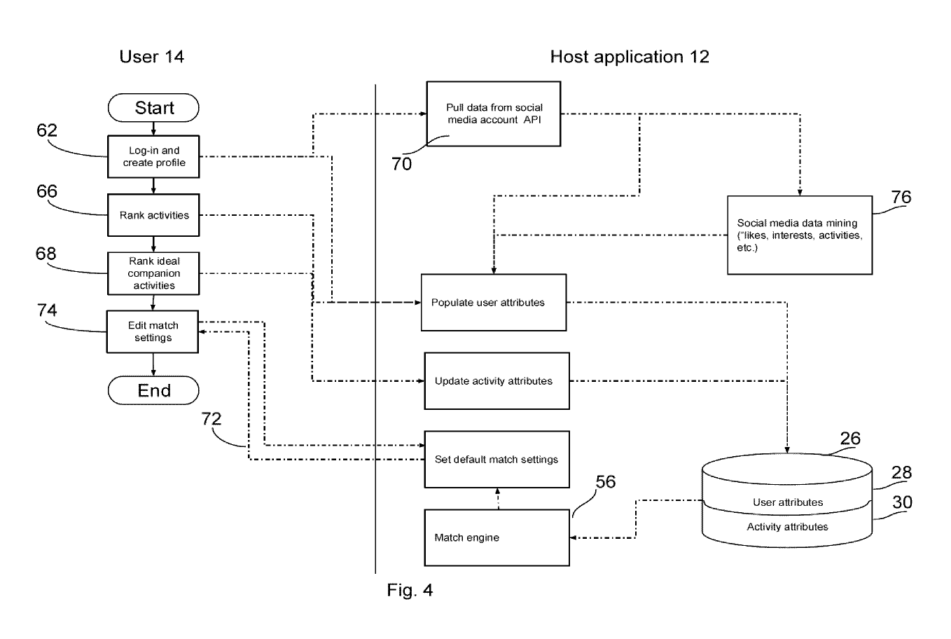

FIG. 4 is a flowchart illustrating the initial user registration process. In registering with the application, a user profile is constructed (62) that is used to extract (64) therefrom user attributes for eventual use in the algorithms used by the activity ranking engine 54 and the match engine 56.

The profile includes the user's stated preference and ranking (66) for types of activities that the user is interested in, including restrictions on certain activities. The profile further records the user's stated expectation (68) of the types of in-person activities that the user believes a compatible matched user is interested in.

The user profile includes intrinsic user attributes 33 such as gender, age, sexual preferences, financial status, race and physical characteristics. The intrinsic user attributes 33 may be drawn (70) in whole or in part from other accessible platforms (e.g. social media platforms) that are associated with the user and that offer relevant attribute information.

The registration process also allows the user to indicate attributes of other users which the user believes will make them a compatible match with that user. The latter may involve the host application proposing (72) a set of default match settings that identify the attributes of a desirable companion but which the user can edit (74).

In one embodiment, the host application 12 includes a social media data mining module 76 that extracts from the user's social media data that is indicative of the user's participation or interest in certain in-person activities.

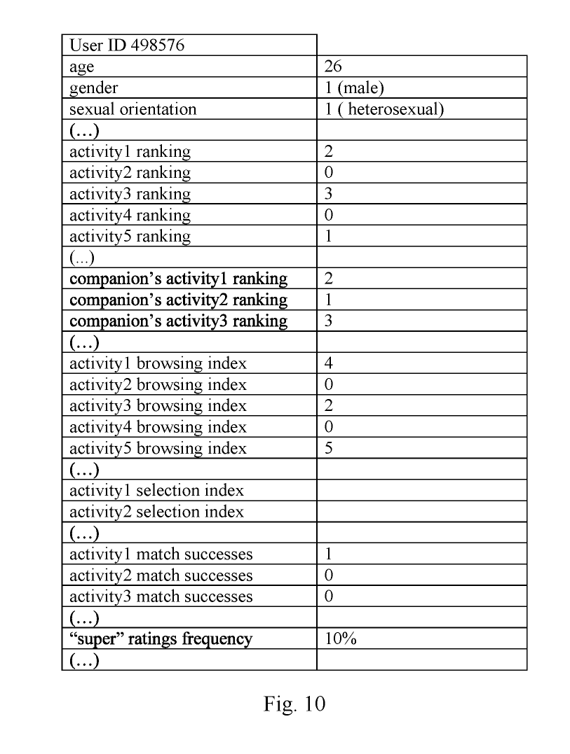

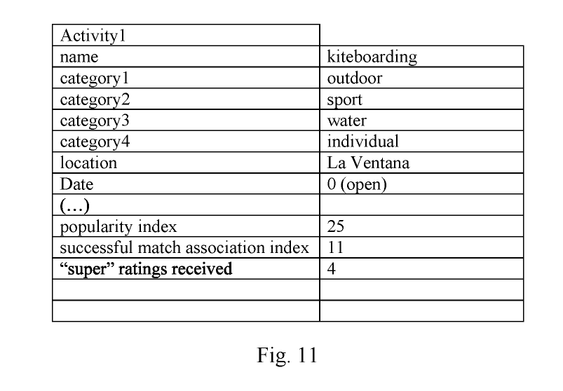

The attribute population module 48 parses the user profile data, including the activity-related data to populate the user 28 and activity 30 attributes. For example, the user attributes may include those identified in FIG. 10. The activity attributes may include those in FIG. 11.

Among the user attributes 28 shown in FIG. 10 are intrinsic user attributes, such as age and gender, while experiential user activity attributes include activity rankings, an activity browsing index reflecting the user's browsing activity among candidate activities, an activity selection index reflecting the activities actually joined/selected by the user and an activity match success count, all relating to the specific user.

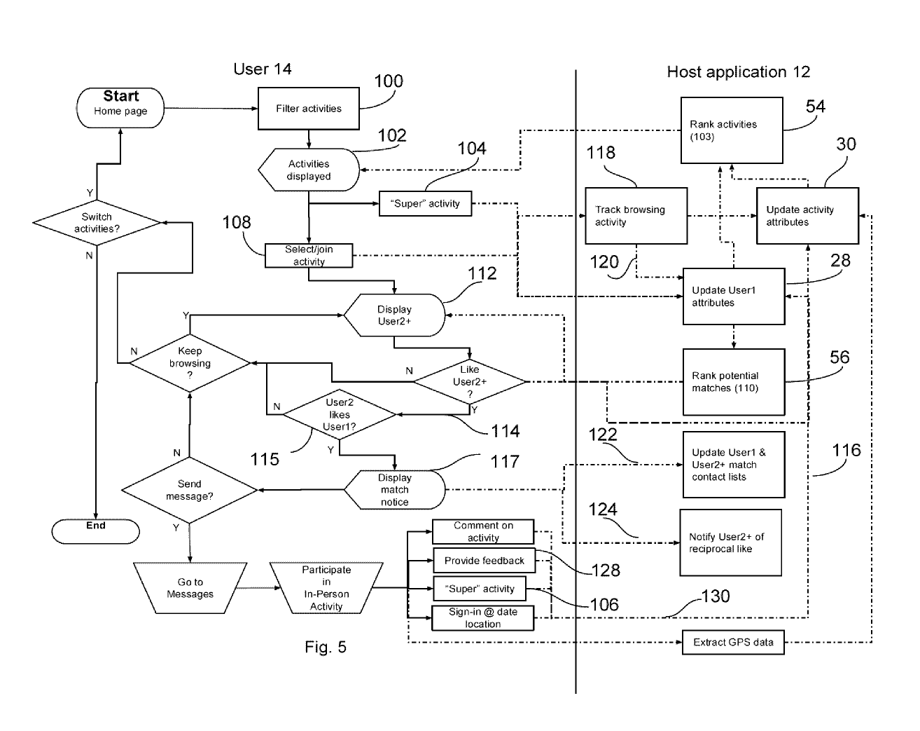

FIG. 5 illustrates the process of selecting an activity for participation. The user logs in and opts to search for a date.

The user is given the option of filtering (100) the activities such as by date, by geographic proximity, by category or by other criteria. In response, the activity ranking engine 54 generates, and the application displays (102), a ranked list of in-person activities that the ranking engine determines are likely to be of interest to the user and that may result in a compatible match for the user. The activities may be displayed by means of images, vines, videos, or any other type of media. The activity ranking engine 54 draws on both the user attributes 28 and the activity attributes 30 to generate (103) a set of candidate activities and to rank them. For example, the user attributes 28 relating to the user's expressed activity preferences (activity1 ranking, activity2 ranking . . . in FIG. 10) are factored into the ranking algorithm. The activity attributes 30 are also factored in. Several of the activity attributes will be relevant to the filter settings applied by the user. In addition, more subtle factors are used such as the popularity of the activity among users generally (“popularity index” in FIG. 11) and how many users have “supered” a given activity (also in FIG. 11).

In one embodiment, the user may elect to receive a display of activities that is generated based on the ranking of activities by others. For example, the user may elect to see the top 10 activities, ranked solely on the basis of their popularity (the “popularity index” in FIG. 11) among all application clients. Alternatively the user may elect to filter the activities on the basis of activities in which other users have actually participated with a matched user, or activities that have been participated in with a certain measure of relationship success.

According to the preferred embodiment, a user may propose (104) a superlative ranking for a given activity by selecting a suitable icon on the user interface. The user may super an activity while browsing (104) the display of ranked activities, after selecting a given activity for participation, or provide such feedback after (106) participating in an in-person activity with a matched user suggested by the host application. In one embodiment, activities may be “liked” rather than supered, and a threshold number of likes from different users is relied on to promote the activity to “supered” status.

According to the preferred embodiment, one of the filters that may be applied to activities by the users is to limit the display to activities that have been “supered” so as to generate a list of potential “superdates”. A temporal filter may be applied to such rankings to provide a more accurate reflection of trending activities.

In the process of the invention, the user selects (108) a particular activity from among the display(s) of ranked activities to pursue a date. The selection triggers an update of the user attributes 28 for the particular user to record the selection of that activity.

Optionally, to facilitate match searches, the user's selection of an activity may be recorded in the activity attributes 30 so as to identify all users who have selected that specific activity within certain temporal or other parameters. The temporal parameters ensure currency of the selection for match purposes. Other parameters include for example whether a given user has already been matched to another user. Thus upon selection of an activity, the match engine need only consult that activity's attributes to identify all other uses who have also selected that particular activity.

In one embodiment, while the user is browsing and exploring potential activities displayed by the activity ranking engine, the user online activity tracking module may monitor (118) the browsing activity to detect apparent user interest in certain activities over others. Such apparent interest in given activities is used to update (120) the user attributes 28 for more effective activity ranking in the future.

The eventual selection (108) of an activity by the user triggers the operation of the match engine 56 that then generates (110) and displays (112) to the user a list of other users (“matches”) who have also selected the same activity for a current date.

The match engine 56 operates an algorithm that applies the user's attributes to filter for other users' attributes that are required for a match (e.g. a user is only interested in other users of the opposite gender) and it may also apply more subtle factors such as the past match history of the user and of other users, and even more subtle factors such as factors derived from successful matches among other users that reflect unexpected attribute correlations. The algorithm produces (110) a ranked list of potential matches for the user and the selected activity and the match engine displays them (112) to the user, preferably one at a time along with the profile of the displayed user for evaluation. The user selects or rejects the displayed match, for example by indicating a “like” (114) of the potential match. Such selection or rejection is recorded in the user attributes (116) so as to more effectively track the user's preferences (by reference to the selected or rejected user's attributes), whether or not the other user's attributes match what the user has recognized as his or her preferences.

Where a user “likes” a match, the match is posted (122) to a match contact list on the user interface of the remote user device 16. A match will not be perfected until the other user that is the subject of the match also reciprocates by selecting or liking the first user (115). Upon such reciprocal selection occurring, a match notification is dispatched (117) and the other user is notified (124) of the reciprocity. Note that this may occur at a relatively later point in time as reciprocal likes are not likely to be simultaneous.

The display of the match notice 117 is accompanied by an enabling of communication between the matched user, preferably using the in-app messaging facility 60.

Following messaging contact, the matched users participate in the selected in-person activity at a face-to-face venue 20.

The effective use of data derived from feedback as to the success of the face-to-face activity is a feature of the preferred embodiment. Such feedback is secured overtly through the solicitation of feedback (128) from the users involved. Upon receiving such feedback, the user attributes 28 (notably as to the activity-related user attributes) and the activity attributes 30 are updated (130).

In the event that a user “supers” an activity on the user interface, such endorsement also comprises overt feedback that is recorded in both the activity-related user attributes and the activity attributes.

The actual attendance at an intended in-person activity is also a metric that can be used in the activities ratings and the user attributes. Where a sign-in and/or sign-out are involved in an in-person activity, the preferred embodiment contemplates communication of the sign-in and sign-out to the host application for the purposes of tracking such attendance, and the duration of the attendance.

A less overt means of securing feedback from users is to data mine the messaging that the users engage in for references to the activity. Subject to prior approval from the users to address privacy concerns, relevant data indicating satisfaction or dissatisfaction with an in-person activity can be used to update the user and activity attributes.

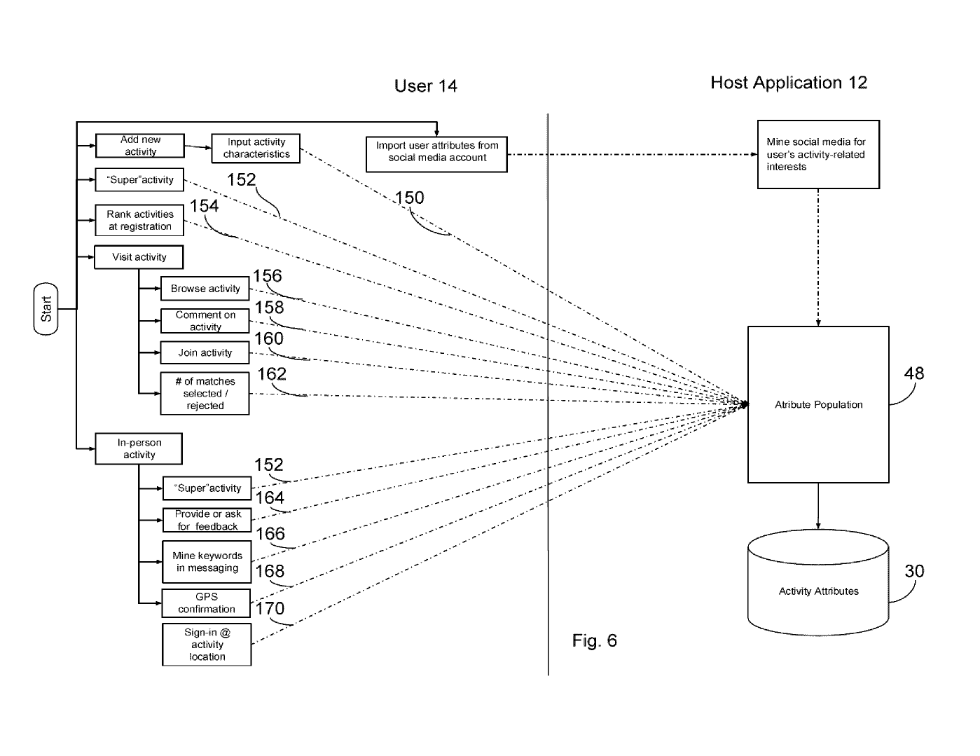

FIG. 6 illustrates the various inputs drawn upon to populate the activity attributes according to the preferred embodiment. As discussed above, they include:
a. activity intrinsic characteristics inputted (150) by users, vendors, the host or sponsors;
b. a user “supering” an activity (152), either when browsing in which case a weighting to the supering attribute may be relatively low, or after participating in the in-person activity in which case the rating is more reliable and the weighting may be relatively high;
c. a user ranking a list of activities upon registration with the application (154) and a user's time spent browsing or returning to an activity online (156); this may be used, for example, to assess overall popularity of given activities for the purposes of future rankings or their popularity in relation to user's having certain attributes;
d. a user commenting on an activity (158);
e. a user joining/subscribing for participation in an activity (160);
f. a user selecting or rejecting potential matches that were based on a given activity (162); such a metric is relevant to the activity attributes for future matching operations;
g. a user responding to solicited feedback regarding an activity (164);
h. favorable or unfavorable references to an activity determined from data mining of the user's messaging activity (166);
i. GPS confirmation of attendance at an in-person activity based on tracking of the user's mobile device 16 (168);
j. monitoring a user's sign-in or sign-out at an activity venue 20 (170);
k. mining a users' social media accounts to determine activity interests.

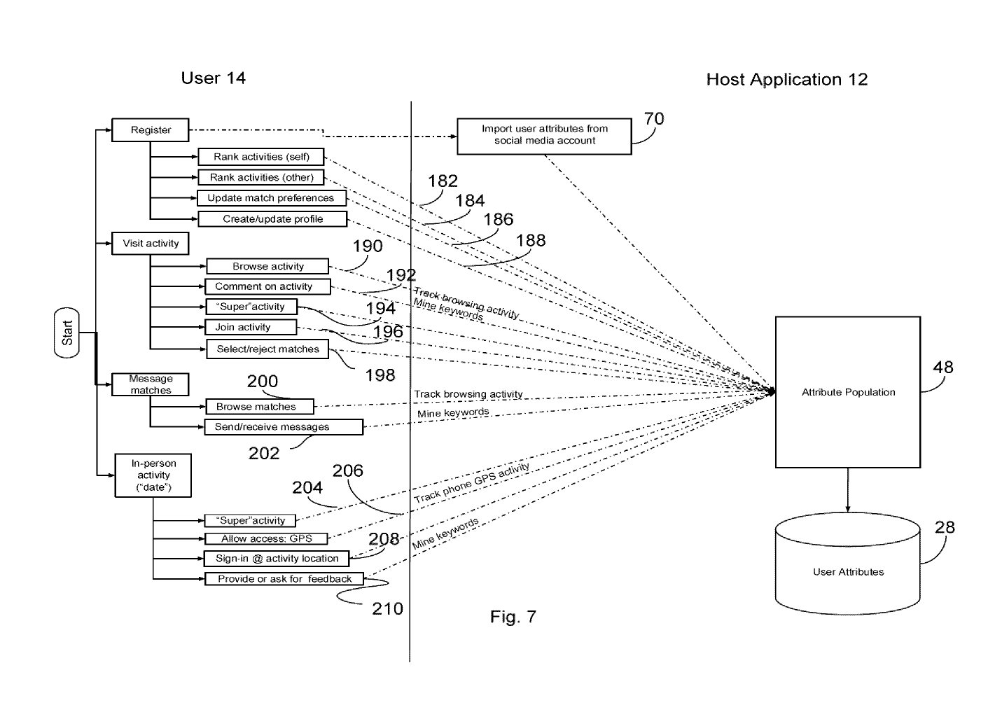

FIG. 7 illustrates the various inputs drawn upon to populate the user attributes according to the preferred embodiment. As discussed above, they include:
a. intrinsic user attribute information drawn from the users' social media accounts when registering with the host application 12 (180);
b. a user's interests in certain in-person activities is itself a user attribute, and the user's ranking of activities upon registration is a user attribute (182);
c. a user's ranking of activities that the user's contemplated ideal match might like, from the user's perspective (184);
d. a user's overtly expressed match preferences (186);
e. a user's self-reported profile information (188);
f. a user's apparent interest in certain activities as monitored by the User

Online Activity Tracking module 44 (190);
g. users' comments on activities (192);
h. activities that are “supered” by users (194);
i. activities joined/subscribed for participation by a user (196);
j. potential matches selected or rejected by a user, as correlated to the activities that generated the potential matches (198);
k. while a user browses potential matches after selecting an activity, the user's browsing activity in relation to each potential match may reveal apparent interest and may therefore be used to populate the user attributes (200);
l. the actual sending or receiving of messages with a potential match or a mutually selected match (202);
m. the actual attendance at an in-person activity, as revealed by supering an activity after attendance (204), GPS tracking of the mobile device 16 (206), monitoring such as by sign-in or sign-out at an activity venue 20 (208) or direct feedback from the user as to the in-person activity (210).

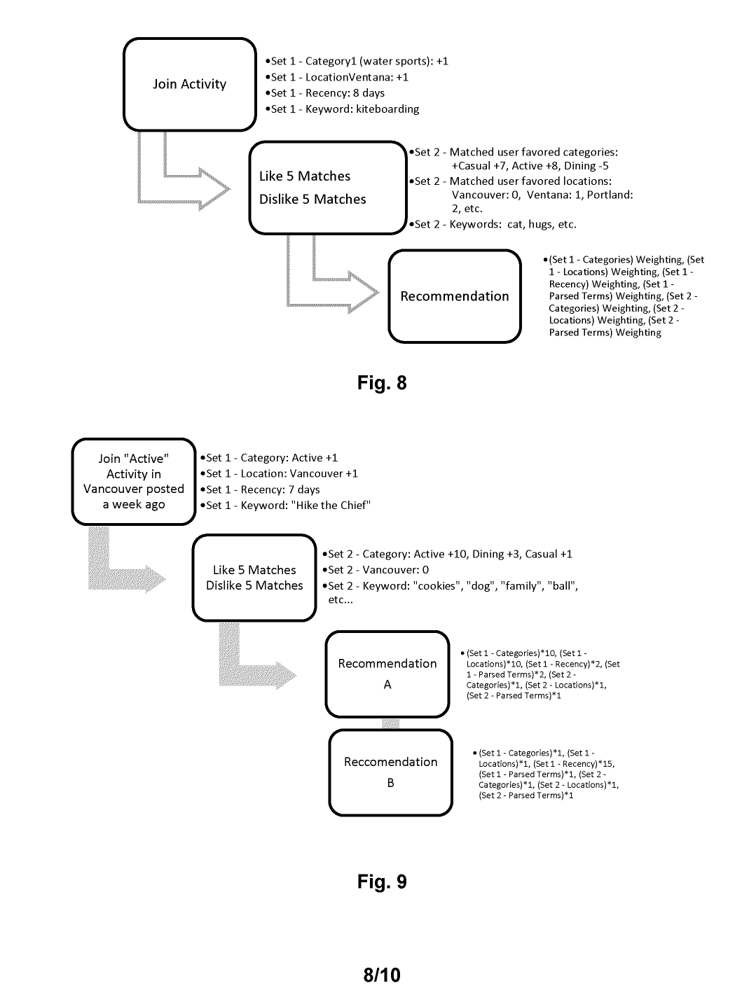

FIG. 8 illustrates the operation of an activity-related recommendation algorithm according to the preferred embodiment. For simplicity, this example is limited in a number of respects. First, the example is limited to reliance on a limited number of attributes. Second the algorithm applies only to the recommendation of an activity, rather than for example, a user match recommendation. As such the described algorithm relates to the “activity ranking engine” of the preferred embodiment. Finally, the described algorithm is used in the particular case where a user has subscribed to participate in an activity, has screened potential matches, but either has yet to consummate an in-person activity date, or wishes to secure other activity recommendations. It will be appreciated that in the preferred embodiment the approach of the algorithm is expanded beyond those particular limitations.

The algorithm preferably treats key computational attributes on a numerical basis for the purposes of weighting and computation. Other word-based attributes may be assessed on a binary basis for the presence or absence of key words. Attributes are given weight and logic depending on a variety of factors including activity level and user behavior. For example, upon registration, a user's behavioral user attributes are nominally nil and increment or decrement in numerical value based on specific behaviors such as joining an activity or liking/disliking matches.

A first set of user attributes (Set 1) comprises attributes directly associated with the given user, while a second set of user attributes (Set 2) comprises attributes projected onto the first user based on the attributes of a second user in which the first user has expressed an interest.

Referring to FIG. 8, upon subscribing to participate in (“joining”) an in-person activity, a user attribute called category1 (water sports) is incremented by 1 for this user. As the activity is designated for La Ventana, Mexico, the attribute associated with that location is incremented by 1 for this user. The activity was posted to the list of activities maintained in the database 8 days ago such that a currency attribute value is set at 8. The activity is identified as “kiteboarding” and this is recorded in the keyword attribute.

Upon the first user being presented with potential match users, the first user selects or rejects each of them. In doing so, the attributes of those other users are used to derive values for the Set 2 attributes of the first user, i.e. attributes of the potential match that might subtly reflect preferences, recognized or not, of the first user.

In the example of FIG. 8, of 5 “likes” and 5 “dislikes”, reference to the activity-related experiences and attributes of the potential matches are taken into account in setting certain analogous attributes for the first user. The 5 “dislikes” users may all have high valued attributes related to “dining”. In view of this, the attribute population module has determined that the first user's Set 2 dining attribute (referencing the first users' relationships with other users) should be decremented by 5. Similarly the “likes” have attracted increments for the Set 2 attributes related to other users' casual and active activity attributes.

The algorithm for recommending another activity for the first user can operate on a weighted computation of attributes considered to be relevant. The weighting can involve weights to both Set 1 and Set 2 attribute values as in the following example:
(Set 1—Categories)*Weighting, (Set 1—Locations)* Weighting, (Set 1—Recency)*Weighting, (Set 1—Parsed Terms) *Weighting, (Set 2—Categories)*Weighting, (Set 2—Locations) *Weighting, (Set 2—Parsed Terms)*Weighting

In an actual implemented algorithm, other factors would be relied on including non-attribute logic.

Recommendation algorithms can be applied in a variety of scenarios in the system of the invention. Different algorithms having varying weights and attributes can be designed to produce recommendations in tandem as a means of varying the ranked activity displays, as illustrated in the example of FIG. 9.

In the preferred embodiment, and for clarity, both “user attributes” and “activity attributes” have been described separately. It will be appreciated however that in an attribute database, the distinction may be largely semantic, and that attributes are not necessarily segregated by such categories. It is however a feature of the invention that activity-related attributes are relied on in the system's recommendation of activities for participation.

Although the preferred embodiment of the invention has described the activity ranking engine and the match engine as separate functional components, it will be appreciated that such nominally separate “engines” may be implemented as part of a unitary artificial intelligence system in which each engine represents different results-oriented operations.

In the foregoing description, exemplary modes for carrying out the invention in terms of examples, the preferred and alternative embodiments have been described. However, the scope of the claims should not be limited by those examples, but should be given the broadest interpretation consistent with the description as a whole. The specification and drawings are, accordingly, to be regarded in an illustrative rather than a restrictive sense.

1. An online system for matching remote users through participation in in-person activities, comprising a host application server, a plurality of remote users each having a remote computing device having a user interface comprising:
a database comprising a list of in-person activities and a set of attributes comprising attributes pertaining to said in-person activities and activity-related attributes of said users;
an activity-ranking engine for determining, based at least on said attributes pertaining to said in-person activities and said activity-related attributes of said users, a first ranked set of activities of likely interest to a first user;
means for displaying said first ranked set of activities to said first user on a remote first user interface of said first user;
said ranking engine for determining, based at least on said attributes pertaining to said in-person activities and on said activity-related attributes of said users, a second ranked set of activities of likely interest to a second user;
means for displaying said second ranked set of activities to said second user on a remote second user interface of said second user;
means displayed on said first user interface enabling said first user to select an in-person activity in which to participate and means on said second user interface enabling said second user to select an in-person activity in which to participate;
means for determining that said first user and said second user have selected a coinciding one of said activities;
means for displaying to said first user on said first user's user interface a notification that said second user has selected said coinciding activity;
means for recording the approval or disapproval by said first user of said second user as a candidate for mutual participation is said coinciding activity;
a notification facility for notifying said first user and said second user when said first user has indicated approval of joint participation is said activity with said second user, and said second user has indicated approval of joint participation in said activity with said first user.

2. The system of claim 1 in which said match engine further determines, based on said attributes, that said first user and said second user are compatible as potential matches for a relationship.

3. The system of claim 1 wherein said notification facility further for presenting to said first user and said second user means for establishing communication between said first user and said second user.

4. A method of matching users of an online dating system having a host application residing on a server and serving a plurality of remote users on respective computing devices, comprising:
prompting each of a plurality of said users to rank their respective preferences in a series of potential in-person activities that are drawn from a database of activities associated with said application;
populating said database with attributes for each of said users, said attributes comprising at least activity-related attributes of respective ones of said users;
in response to an action from a first user, generating a first set of said in-person activities, said step of generating being based on one or more of said activity-related attributes relating to said first user, and displaying said first set of in-person activities to said first user as an invitation to subscribe for participation in one of said first set of in-person activities;
receiving from said first user a selection of a first specific activity from said first set;
in response to an action from a second user, generating a second set of said in-person activities, said step of generating being based on one or more of said activity-related attributes relating to said second user, and displaying said second set of in-person activities to said second user as an invitation to subscribe for participation in one of said second set of in-person activities;
receiving from said second user a selection of a second specific activity from said second set;
assessing whether said second specific activity is said first specific activity;
if said second specific activity is said first specific activity, assessing whether said second user is a potential relationship match for said first user, based at least on personal attributes of each of said first and second user, and activity-related attributes of each of said first and second user;
if said second specific activity is said first specific activity and said second user is assessed as being a potential relationship match for said first user, displaying identifying information regarding said second user to said first user;
upon said first user indicating a desire to participate in said first specific activity with said second user and said second user indicating a desire to participate in said first specific activity with said first user, displaying to each of said first and second users a notification of a mutual desire to participate in said activity jointly.

5. The method of claim 4 further comprising the steps of:
displaying to said first user identifying information for respective ones of a plurality of users who have selected said first specific activity; and,
upon said first user indicating a desire to participate in said first specific activity with a specific one of said plurality of users who have selected said first specific activity, displaying to each of said first user and said specific one of said plurality of users a notification of a mutual desire to participate in said activity jointly.

6. The method of claim 5 further comprising the step of:
determining that said first user and said second user have participated in said first specific activity together;
receiving feedback regarding satisfaction on the part of said first user or said second user with their participation in said first specific activity;
populating said database with activity-specific attributes corresponding to said satisfaction, said first user and said first specific activity.

7. The method of claim 6 further comprising the steps of:
receiving from said first user a proposed superlative characterization of said first specific activity, and
populating said database with at least one activity-specific attribute reflecting said proposed superlative characterization.

8. The method of claim 4 wherein said activity-specific attributes comprise at least one attribute derived from one of the following group:
said first user ranking of a set of in-person activities on one of said computing devices; browsing of activities by said first user; said first user subscribing to participate in an activity; said user proposing a superlative characterization for an activity; said first user selecting or rejecting proposed other users for jointly participating with in an activity; said first user's actual participation in an activity; GPS information indicating said first user's participation in an activity; explicit feedback from said first user in relation to participation in an activity; data mining of messages involving said first user and relating to an activity; a success rate as a result of users participating in an activity.
